(19) United States
(12) Patent Application Publication
(10) Pub. No.: US 2021/0284416 A1
(43) Pub. Date: Sep. 16, 2021

(54) PEELABLE PACKAGE

(71) Applicant: Church & Dwight Co., Inc., Princeton, NJ (US)

(72) Inventors: Michael T. Pinchiaroli, Martinsville, NJ (US); Richard James Elliott Gilbert, Belle Mead, NJ (US); Jonathan Andrew Wharton, Ewing, NJ (US); James Bernard Oldham, Chester, VA (US); William D. Platt, Lumberton, NJ (US); Caryn Culleton Oryniak, Hillsborough, NJ (US); Gerhart P. Huy, Hamilton Square, NJ (US); Rajesh Ranjan, Princeton, NJ (US); Velissa Van Scoyoc, Philadelphia, PA (US); David Schweitzer, Weston, CT (US); Jacob Daniel Taylor, Chicago, IL (US)

(73) Assignee: Church & Dwight Co., Inc., Princeton, NJ (US)

(21) Appl. No.: 17/197,968

(22) Filed: Mar. 10, 2021

Related U.S. Application Data
(60) Provisional application No. 62/987,987, filed on Mar. 11, 2020.

(51) Int. Cl. B65D 75/58; B65D 75/32; B65D 81/24

(52) U.S. Cl. CPC B65D 75/5838; B65D 81/24; B65D 75/322

(57) ABSTRACT

The present disclosure provides packaged articles that can provide improved ease of access to the articles. More particularly, such packaged articles can comprise a plurality of multilayer films with a product contained therebetween. The multilayer films can be sealingly engaged one to another substantially only at a perimeter band that defines a closed, interior compartment in which the product is contained and which defines a tab section that is exterior to the perimeter band. At least a section of the perimeter band proximate to the tab section can be configured as a peel-apart seal such that the interior compartment containing the product is accessible by at least partially peeling apart the multilayer films. The disclosure further provides methods of packaging a product, such as a condom, and methods for improving ease of access to a packaged article, such as a condom.

### CROSS-REFERENCE TO RELATED APPLICATIONS

The present patent application claims priority to U.S. Provisional Patent Application No. 62/987,987, filed Mar. 11, 2020, the disclosure of which is incorporated herein by reference.

### FIELD OF THE DISCLOSURE

The present disclosure relates to packaging for consumer products, preferably products having a relatively thin profile. More particularly, the present disclosure relates to packaging that can exhibit improved ease of opening and remain functional as a disposal unit for the contents of the package once used.

### BACKGROUND

Packaging is known for a variety of consumer product that may be sold in individual units. As an example, prophylactics, or condoms, may be routinely provided individually packaged, such as in foil packs. Such foil packs are designed to be opened by tearing or cutting so that a portion of the package may be removed to provide access to the condom stored therein. Similar packaging may be provided for a variety of different products that may have a relatively slim profile, such as alcohol wipes, disinfecting wipes, and other types of products. In the case of at least condoms, however, there can be a significant chance for damaging the condom itself while opening the packaging. This can be particularly the case where a consumer may have reduced dexterity or hand strength for easily tearing open the package only around a perimeter so that the tear does not extend across the body of the condom. If such tearing across the body of the condom occurs, there can be doubt as to whether the relatively thin material forming the condom may have been ripped or torn during opening of the package. As such, condoms that are undamaged may be discarded out of abundance of caution while condoms that are damaged during opening may be used without knowing that damage has occurred during opening. Accordingly, there remains a need in the art for further packaging, including packaging for condoms, that can provide ease of opening and increase assurance to the consumer that the product retrieved from the packaging did not sustain damage during opening of the packaging.

### SUMMARY OF THE DISCLOSURE

The present disclosure relates to packaging for one or more articles, packaged articles, and methods of packaging various articles. The packaging may be particularly useful for prophylactic products, such as condoms. The packaging beneficially allows for ease of opening to ensure that the product included therein remains undamaged during the action of opening.

In one or more embodiments, the present disclosure thus can provide packaged articles comprising: a first multilayer film; a second multilayer film; and a product; wherein the first multilayer film and the second multilayer film are sealingly engaged one to another substantially only at a perimeter band that defines a closed, interior compartment in which the product is contained and which defines a first tab on the first multilayer film and a second tab on the second multilayer film, the first tab and the second tab being exterior to the perimeter band; and wherein at least a section of the perimeter band proximate to the first tab and the second tab is configured as a peel-apart seal such that the interior compartment containing the product is accessible by at least partially peeling apart the first multilayer film and the second multilayer film. The packaged articles may be further defined in relation to one or more of the following statements, which may be combined in any number or order.

The first multilayer film and the second multilayer film each can comprise at least an inner, polymeric layer and at least one structural layer that is exterior thereto.

The at least one structural layer can include one or more of a foil layer, a polyolefin layer, and a polyester layer.

The at least one structural layer can be effective as one or both of an oxygen barrier and a moisture barrier.

The polymeric layer of the first multilayer film and the second multilayer can be formed of a material that is configured to form the peel-apart seal upon application of an activating factor.

The activating factor can be one or a combination of heat, pressure, and dwell time.

The at least a section of the perimeter band that is configured as a peel-apart seal can be configured such that the peel-apart seal does not separate below a peel force of about 1.5 pounds per 15 mm of linear distance.

The at least a section of the perimeter band that is configured as a peel-apart seal can be configured such that the peel-apart seal separates at a peel force of about 1.5 pounds to about 3.0 pounds per 15 mm of linear distance.

A first section of the perimeter band proximate to the first tab and the second tab is configured as a peel-apart seal and can be configured such that the peel-apart seal separates at a first peel force, and a second section of the perimeter band can be configured as a peel-apart seal and can be configured such that the peel apart seal separates at a second peel force that is greater than the first peel force.

A first section of the perimeter band proximate to the first tab and the second tab can be configured as a peel-apart seal and can be configured such that the peel-apart seal separates at a defined peel force, and a second section of the perimeter band can be configured to not be a peel-apart seal.

The perimeter band can include a plurality of stops that are configured to resist peeling apart of the first multilayer film and the second multilayer film.

The plurality of stops can be positioned relative to the first tab and the second tab such that about 30% to about 80% of the perimeter band can be peeled apart prior to reaching the plurality of stops.

The first multilayer film and the second multilayer film can have substantially the same size and shape.

The perimeter band can be re-sealable.

The first multilayer film and the second multilayer film each can comprise four corners.

The at least a section of the perimeter band that is configured as the peel-apart seal can be proximate to two of the four corners.

The first tab and the second tab encompass a first corner of the four corners and extend to two adjacent corners.

The perimeter band can be configured with two substantially full length perimeter band sections that interconnect at one of the corners in a substantially right angle.

The perimeter band can be configured with a partial length perimeter band section extending from one of the corners along one of the sides.

The partial length perimeter band section can include an outer edge, and wherein the partial length perimeter band section is angled relative to the side so as to form an angle of about 1 degree to about 60 degrees.

The perimeter band can be configured with two partial length perimeter band sections extending from two, opposing corners along two adjacent sides toward a third corner interconnecting the two adjacent sides.

Each of partial length perimeter band sections can include an outer edge, and wherein the partial length perimeter band sections are individually angled relative to their respective sides so as to form an angle of about 1 degree to about 60 degrees.

The first multilayer film and the second multilayer film can have a substantially curved edge.

The first multilayer film and the second multilayer film can have an outer edge defining a substantially round or oval profile.

The product can be a condom.

In one or more embodiments, the present disclosure can provide methods of packaging a condom. In particular, such method can comprise: positioning a condom between a first multilayer film and a second multilayer film; and sealing the first multilayer film and the second multilayer film substantially only at a perimeter band that substantially surrounds the condom to define a closed, interior compartment in which the condom is contained and to define a first tab on the first multilayer film and a second tab on the second multilayer film, the first tab and the second tab being exterior to the perimeter band; wherein the sealing is carried out such that at least a section of the perimeter band proximate to the first tab and the second tab is configured as a peel-apart seal such that the interior compartment containing the condom is accessible by at least partially peeling apart the first multilayer film and the second multilayer film.

In some embodiments, the present disclosure further can provide methods for improving ease of access to a packaged condom. In particular, such methods may comprise providing a condom within a sealed, peelable package. More specifically, the sealed, peelable package may comprise: a first multilayer film; and a second multilayer film; wherein the first multilayer film and the second multilayer film can be sealingly engaged one to another substantially only at a perimeter band that defines a closed, interior compartment in which the condom is contained and which defines a first tab on the first multilayer film and a second tab on the second multilayer film, the first tab and the second tab being exterior to the perimeter band; and wherein at least a section of the perimeter band proximate to the first tab and the second tab can be configured as a peel-apart seal such that the interior compartment containing the condom is accessible by at least partially peeling apart the first multilayer film and the second multilayer film.

### BRIEF DESCRIPTION OF THE DRAWINGS

FIG. 1 is a perspective view of a packaged article according to embodiments of the present disclosure, wherein multilayer films forming the package are partially peeled apart to access a product stored therein.

FIG. 2 is a partial cross-section of a multilayer film useful in forming packages according to embodiments of the present disclosure.

FIG. 3 is a plan view of a packaged article according to embodiments of the present disclosure illustrating an example configuration of the sealed, perimeter band and associated storage compartment and tab section.

FIG. 4 is a plan view of a packaged article according to further embodiments of the present disclosure illustrating an example configuration of the sealed, perimeter band and associated storage compartment and tab section.

FIG. 5 is a plan view of a packaged article according to additional embodiments of the present disclosure illustrating an example configuration of the sealed, perimeter band and associated storage compartment and tab section.

FIG. 6 is a plan view of a packaged article according to the present disclosure illustrating differences in various portions of the perimeter band.

FIG. 7 is a plan view of a packaged article according to the present disclosure illustrating various positions for stops that can be configured to limit peeling apart of the multilayer films.

FIG. 8 is a plan view of a packaged article according to embodiments of the present disclosure illustrating an example configuration of the sealed, perimeter band and associated storage compartment and tab section.

FIG. 9 is a plan view of a packaged article according to embodiments of the present disclosure particularly illustrating suitable locations for placement of indicia for informing a user of where the package may be peeled for opening thereof.

### DETAILED DESCRIPTION OF THE DISCLOSURE

The invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present disclosure relates to packaging useful for various products and particularly for prophylactic devices, such as condoms. The disclosure thus can relate to a packaged article that includes outer packaging (e.g., formed from a plurality of multilayer films) and a product stored therein. The disclosure also can relate to methods of preparing packaged articles and particularly packaged condoms.

Packaging for condoms it typically configured to be minimal and discrete. Often, the condom is packaged between sheets of a heat sealable laminated film of aluminum foil, plastics, and/or paper. As such, the package is typically configured to be torn or cut open for removal of the condom, and the package itself provides little or no use thereafter. The presently disclosed packages are adapted to or configured to not only provide protective storage of the condom but also provide improved ease of opening of the package so there is little or no doubt that the condom was not damaged during opening of the package.

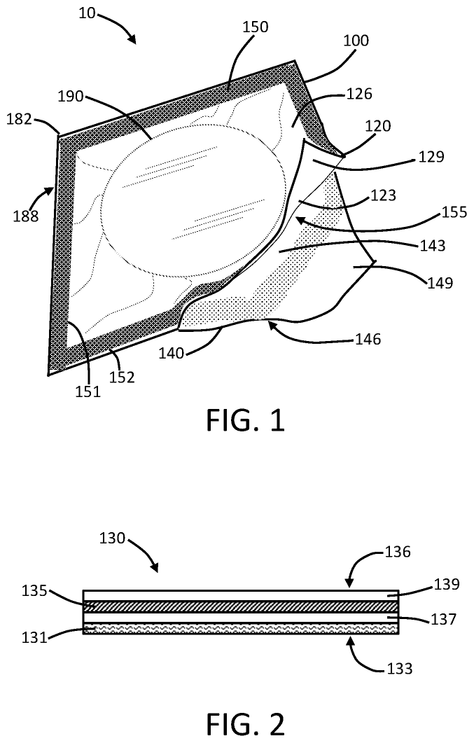

The present disclosure, in one or more embodiments, thus can provide packaging for items as well as packaged articles including the packaging and the article or product stored therein. As seen in FIG. 1, a package 100 can comprise a first multilayer film 120 and a second multilayer film 140. One of the first multilayer film 120 and the second multilayer film 140 may be characterized as being a top layer or upper layer of the package 100, and the other of the first multilayer film and the second multilayer film may be characterized as being a bottom layer or lower layer of the package. In some embodiments, a single piece of a multilayer film may be folded over on itself to define the first multilayer film 120 and the second multilayer film 140. As such, the use of a plurality of multilayer films is intended to encompass a single strip of a multilayer film that is folded to define first and second multilayer films. In some embodiments, however, such folded configuration may be expressly excluded and, as such, two discrete and separate pieces of film may be combined to form the package 100. Preferably, the first multilayer film 120 and the second multilayer film 140 are substantially the same size and shape.

A multilayer film for use according to the present disclosure can be a film material comprising a plurality of layers, such as two or more layers, three or more layers, four or more layers, or five or more layers. An example embodiments of a multilayer film 130 according to the present disclosure is illustrated in FIG. 2, and such film can be suitable for use in forming one or both of the first multilayer film 120 and the second multilayer film 140. As seen in FIG. 2, the multilayer film can comprise at least an inner layer 131 and at least one structural layer 135 that is exterior to the inner layer. Optional layer 137 and optional layer 139 are shown in FIG. 2, but one or more layers at each position may be expressly absent. Each of the illustrated layers 131, 135, 137, 139 may represent a single layer or a plurality of layers (e.g., two or more inner layers, two or more structural layers, two or more optional layers between the inner layer(s) and the structural layer(s), and two or more optional layers exterior to the structural layer(s)). Likewise, when a plurality of structural layers is used, one of the structural layers may be present as the outermost layer. The inner layer 131 can define an inner surface 133 of the multilayer film 130, and one of the further layers can define an outer surface 136 of the multilayer film. It is understood that the multilayer film 130 in FIG. 2 is suitable for use in any of its possible embodiments as the first multilayer film 120 and as the second multilayer film 140 as shown in the remaining figures.

The structural layer(s) 135 can comprise any material that is suitable to provide structural support and strength to the package. For example, a suitable structural layer may comprise a metal foil, such as an aluminum foil. It is understood, however, that other structural materials, such as polymeric materials, may be used instead of a metal foil or in addition to an aluminum foil. Non-limiting examples of other suitable structural materials include polyesters, such as polyethylene terephthalate (PET), polyolefins, such as high density polyethylene (HDPE), polyvinyl acetates (PVA), and similar materials. Thus, at least one structural layer present in the multilayer film can be one or more of a foil layer, a polyolefin layer, and a polyester layer. The at least one structural layer, in one or more embodiments, can be adapted to be or configured to be effective as one or both of an oxygen barrier and a moisture barrier.

The inner layer 131 can be formed of a polymeric material or combinations of polymeric materials that can be adapted to or configured form a sealing engagement that substantially prevents liquids and/or gases from entering the package but is peelable so as to allow for ease of opening of the package. The polymeric material particularly can be a polymeric resin including one or more polymer components and may be referred to as a “seal and peel” polymer. For example, polybutene-1 (PB-1) may be used and may be combined with low density polyethylene (LDPE) and/or linear low density polyethylene (LLDPE). Ethylene propylene (EP) peel polymer is a fully formulated copolymer that is commercially available and may be used as a seal and peel polymer. Likewise, crosslinked ionomeric resins (i.e., ionomers) may be used as seal and peel polymers or as a layer adjacent to a seal and peel polymer layer to assist in the ease of peeling open the package.

In some embodiments, the multilayer film 130 may include one or more tie layers. For example, in FIG. 2, layer 137 may be a tie layer between the inner polymer layer 131 and the structural layer 135. A tie layer may comprise a polymeric resin that is adapted to or configured to improve adhesion between layers formed of dissimilar materials. For example, suitable materials for use in a tie layer can include ionomers and polyolefins. More particularly, resins such as ethylene-vinyl acetate (EVA), ethylene-methyl acrylate (EMA), and ethylene-acrylic acid (EAA) may be used in tie layers.

In a non-limiting example, a suitable multilayer film for forming a package according to the present disclosure may include at least five layers. For example, such multilayer film may include, from inside to outside, a polymeric seal and peel layer, a tie layer, a first structural layer, a further tie layer, and a second structural layer. The structural layers in particular may be a metal foil and/or a polymeric material. The tie layers in particular may be an ionomer and/or a polyolefin. Suitable multilayer films are commercially available, such as from Winpak Heat Seal Packaging.

A multilayer film may have an overall thickness of about 25 μm to about 500 μm, about 30 μm to about 300 μm, or about 50 μm to about 200 μm, which thickness may be evaluated using test method ASTM F2251. Such films preferably can have a basis weight of about 50 gsm (g/m²) to about 400 gsm, about 60 gsm to about 300 gsm, or about 75 gsm to about 200 gsm, which basis weight may be evaluated using test method ASTM D646.

In some embodiments, the inner polymeric layer 131 can be adapted to or configured to form a peel-apart seal upon application of an activating factor. As such, only portions of the multilayer film that are subjected to the activating factor will be sealed together. As non-limiting examples, a suitable activating factor can be one or a combination of heat, pressure, and dwell time (i.e., the length of time during which one or both of heat and pressure are applied). Heat and/or pressure can be applied in a manner that provides a stippled effect (e.g., knurling) in the area of the perimeter band to clearly indicate the sealing zone. In other embodiments, however, a substantially flat seal can be applied, and the flat seal embodiment can be fully visualized relative to the figure in that the flat seal would exist in substantially the same location as the illustrated seal, but the knurling would be absent, and the sealed area would be substantially flat instead of being textured. For example, in some embodiments, sealing may be carried out applying a pressure in the sealing zone of about 300 Newtons (N) to about 600 N, about 350 N to about 550 N, or about 400 N to about 500 N. As a further example, heat can be applied to the sealing zone at a temperature of about 175° C. to about 250° C., about 180° C. to about 240° C., or about 190° C. to about 220° C. In some embodiments, the application of the activating factor can relate to a processing speed of the packaging process (i.e., the “dwell time” noted above) so that heat and/or pressure are applied for the correct amount of time to achieve the desired sealing configuration. For example, heat and/or pressure as defined above may be applied during processing at a line speed of about 40 units per minute to about 80 units per minute, about 50 units per minute to about 70 units per minute, or about 55 units per minute to about 65 units per minute.

Returning to FIG. 1, in the illustrated embodiment of a package 100, the first multilayer film layer 120 and the second multilayer film layer 140 are combined such that an inner surface 123 of the first multilayer film is facing an inner surface 143 of the second multilayer film while an outer surface 126 of the first multilayer film and an outer surface 146 of the second multilayer film form an exterior of the package. A product 190 (a condom in the illustrated embodiment of FIG. 1) is shown as still being present in the package 100 to provide a packaged article 10.

The presently disclosed, packaged articles beneficially are adapted to or configured to provide desirable sealing properties to secure the product 190 within the package 100; however, the sealing is adapted to or configured to be in a peel-apart configuration such that the two multilayer films may be easily peeled apart for removal of the product. In some embodiments, the first multilayer film 120 and the second multilayer film 140 can be sealingly engaged one to another substantially only at a perimeter band 150 that defines a closed, interior compartment 155 in which the product 190 is contained. The perimeter band 150 thus defines the perimeter of the interior compartment 190 and, more particularly, an inner edge 151 of the perimeter band 150 can define an outer boundary of the interior compartment. The perimeter band 150 also can include an outer edge 152, and a distance between the inner edge 151 and the outer edge can define a width of the perimeter band. In some embodiments, the perimeter band can have a width of about 1 mm to about 10 mm, about 1.5 mm to about 8 mm, or about 2 mm to about 6 mm.

The packaged article 10 can take on a variety of shapes, as further discussed herein, and the packaged article can be characterized in some embodiments in relation to the side(s) or edge(s) 188, which define the outer boundary or perimeter of the packaged article. For example, in FIG. 1, the article 10 is substantially a quadrilateral and includes four sides or edges 188 and four intervening corners 182. The perimeter band 150 can be configured so that the outer edge 152 thereof is substantially congruent or coincident with the side(s) or edge(s) 188 of the article 10 around a part of the article. Substantially congruent or coincident thus means that the outer edge 152 of the perimeter band 150 is sufficiently close to the side or edge 188 of the article along the noted portion thereof so that the first multilayer film 120 and the second multilayer film 140 are sealed together at the noted portion of the side or edge or such that any area of the first multilayer film and the second multilayer film that is not sealed together is sufficiently small so that a user may not grasp the individual multilayer films and peel apart the individual multilayer films. The outer edge 152 of the perimeter band 150 thus can abut the side or edge 188 at the noted portion thereof.

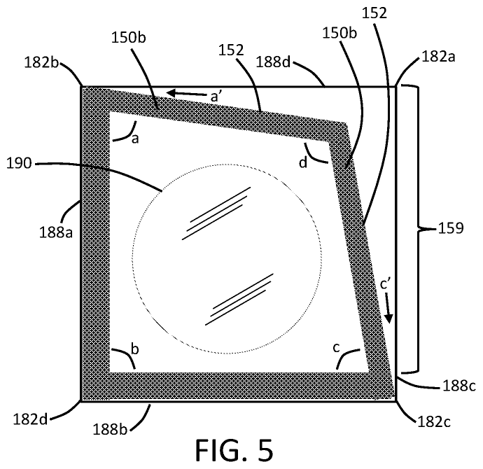

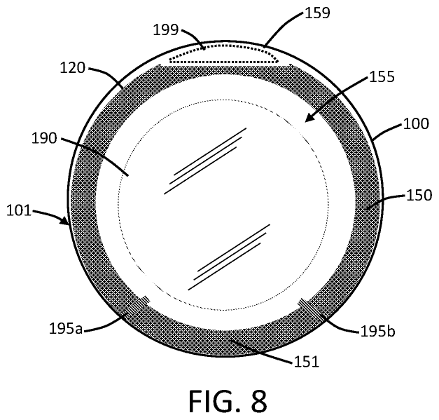

In defined portions of the packaged article 10, the perimeter band 150 can be specifically positioned and/or shaped so that the outer edge 152 of the perimeter band is inset from the side or edge 188 of the article along the defined portion. The area of the first multilayer film 120 and the second multilayer film 140 defining this inset portion will thus not be sealed together and can provide a tab section 159 including a first tab 129 on the first multilayer film 120 and a second tab 149 on the second multilayer film 140. In this manner, the tab section 159 including the first tab 129 and the second tab 149 defines and area that is bounded by a portion of the side or edge 188 of the packaged article 10 and a portion of the outer edge 152 of the perimeter band. The tab section 159, and particularly the first tab 129 and the second tab 149 can thus be characterized as being exterior to the perimeter band because they are positioned between a portion of the perimeter band and the outer edge or side of the package. The tab section 159 can have a variety of shapes and sizes. For example, a tab (129, 149) can comprise about 1% to about 25%, about 2% to about 20%, about 5% to about 20%, or about 5% to about 15% of the surface area of a multilayer film forming the package. In this manner, a portion of the edge of the packaged article will define a boundary of the tab section that allows for peeling apart of the two multilayer films. A tab section thus can be defined as a portion of the first multilayer film layer 120 and the second multilayer film layer 140 that is positioned between the outer edge 152 of the perimeter band 150 and the outer periphery of the packaged article. For example, the outer periphery can be defined by sides 188a-188d and corners 182a-182d (see FIG. 5) in the case of a substantially quadrilateral package, or can be defined by an outer edge 101 (See FIG. 8) in the case of a substantially rounded (e.g., circle or ellipse) package.

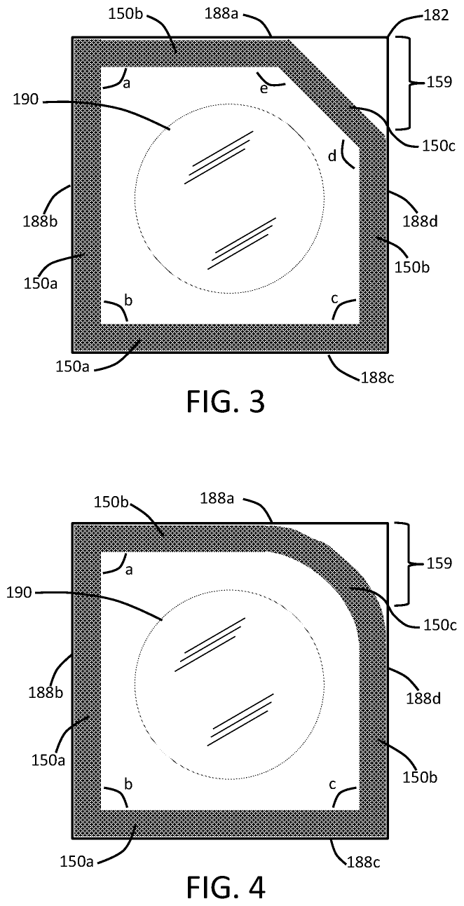

The first multilayer film 120 and the second multilayer film 140 may be defined in relation to having at least one corner 182 or having a plurality of corners. In some embodiments, the first multilayer film 120 and the second multilayer film 140 can each comprise four corners 182 in relation to a substantially quadrilateral shaped article; however, as other shapes are also envisioned (e.g., triangle, pentagon, hexagon, heptagon, octagon, or the like), a lesser or greater number of corners may be present. In various embodiments, the first tab 129 of the first multilayer film layer 120 and the second tab 149 of the second multilayer film 140 may each encompass a corner 182 (which may be a first corner when a plurality of corners is present) of the respective multilayer film. Utilizing a corner 182 as forming at least part of a tab (129, 149) can be beneficial to provide adequate space for gripping the tab without taking an excessive amount of the packaging away from the storage of the product. This also can allow for a variety of configurations for the perimeter band 150 that is formed by the sealing together of the first multilayer film 120 and the second multilayer film 140. As seen in FIG. 3, a portion of the perimeter band 150 that is proximate to the tab section 159 is substantially straight and interconnects perimeter band sections present along sides 188 of the multilayer film that terminate at the tab section. As a result, five inner angles (a-e) are defined by the perimeter band 150. In such embodiment, three of the inner angles (a-c) are approximately right angles (i.e., 90 degrees+/−5 degrees), and two of the inner angles (d-e) are obtuse angles. In such embodiments, the perimeter band 150 may be defined as being a plurality of individual perimeter band sections. Moreover, individual perimeter band sections may extend along the full length of two adjoining sides of the packaged article 10 (i.e., sides 188a and 188b in FIG. 3) and may extend along only a portion of the length of two adjoining sides of the packaged article (i.e., sides 188a and 188d in FIG. 3). The embodiment of FIG. 3 thus has two full length perimeter band sections 150a and has two partial length perimeter band sections 150b. Having the perimeter band sections extend along only a portion of the length of two adjoining allows for the formation of the tab section 159 at the intervening corner that is between the two adjoining sides. A fifth section of the perimeter band can thus interconnect the two partial length perimeter band sections to fully enclose the product 190 within the so-formed interior compartment 155. In FIG. 3, the interconnecting perimeter band section 150c is linear.

In the example embodiment of FIG. 4, the interconnecting perimeter band section 150c that is proximate to the tab section 159 is substantially curvilinear and again interconnects the partial length perimeter band sections 150b present along sides 188a and 188d of the multilayer film that terminate at the tab section. Thus, three inner angles (a-c) are still defined and are approximately right angles, and the interconnecting perimeter band section 150c is an arc section.

In the example embodiment of FIG. 5, the perimeter band 150 is again formed of substantially straight sections along the four sides (188a-188d) of the packaged product. The individual sections of the perimeter band 150 extending at least partially along the four sides (188a-188d) are configured so that they intersect with adjacent sections to form a variety of angles. The portions of the perimeter band 150 along adjoining sides 188a and 188b are configured as full length perimeter band sections and intersect proximate corner 182d to form an angle b that is approximately a right angle. In some embodiments, as shown in FIG. 5, the perimeter band is only defined with only a single angle that is approximately a right angle. The angles formed proximate the corners immediately on either side of the corner defining the right angle are preferably configured to be acute angles. More particularly, the full length perimeter band section spanning side 188a and the partial length perimeter band section spanning a portion of side 188d can intersect to form an angle a that is an acute angle. Likewise, and the full length perimeter band section spanning side 188b and the partial length perimeter band section spanning a portion of side 188c can intersect to form an angle c that is an acute angle. In some embodiments, the acute angles a and c can independently be an angle of about 50 degrees to about 80 degrees, about 55 degrees to about 75 degrees, or about 60 degrees to about 70 degrees.

The partial length perimeter band sections spanning portions of sides 188c and 188d can be positioned to form defined angles (a′ and c′) between the outer edge 152 of the partial length perimeter band section and the respective side or edge (188c or 188d) of the packaged product 10. The angles a′ and c′ can be acute angles. In various embodiments, the angles a′ and c′ can independently be in the range of about 1 degree to about 60 degrees, about 5 degrees to about 40 degrees, or about 10 degrees to about 30 degrees. The partial length perimeter band sections 150b along sides 188c and 188d can intersect to form an angle d that can be an obtuse angle. The angle d, in some embodiments, can be about 95 degrees to about 150 degrees, about 100 degrees to about 140 degrees, or about 105 degrees to about 130 degrees.

In light of the foregoing configurations of the four perimeter band sections along the four sides 188a-188d) of the packaged article 10, the partial length perimeter band sections 150b on the two adjoining sides 188c and 188d are angled inwardly (relative to the respective sides) so as to intersect with one another and thus provide an area of the multilayer films that is not sealed together and thus functions as the tab section 159. In this manner, the tab section 159 can encompass a first corner 182a and extend at least partially to two adjacent corners 182b, 182c. This provides for a significantly larger tab section 159 that can improve ease of gripping to open the packaged article 10. Accordingly, the angular arrangement of the partial length perimeter band sections 159 along sides 188c and 188d can be adjusted to provide angles a, a′, c, c′, and d that can vary to provide the tab section 159 with a greater or lesser area as a starting point for peeling apart the two multilayer films. This area can then be adjusted as need to balance the required peeling force to open the package with the gripping area allotted by tab section 159. For example, if a greater peeling force is required to open the package, a greater area can be allotted for tab section 159, and if a lesser peeling force is required, a lesser area can be allotted for the tab section.

In some embodiments, a tab section 159 can be present at only one corner of the packaged article 10. In some embodiments, a tab section 159 can be provided at a plurality of corners of the packaged article 10.

In some embodiments, at least a section of the perimeter band 150 that is formed as a sealing zone between the first multilayer film 120 and the second multilayer film 140 can be configured as a peel-apart seal. If desired, substantially the entire perimeter band 150 that is formed as a sealing zone between the first multilayer film 120 and the second multilayer film 140 can be configured as a peel-apart seal. Preferably at least a section of the perimeter band 150 that is proximate to the tab section 159 (e.g., including the first tab 129 and the second tab 149) can be configured as a peel-apart seal. Moreover, a section of the perimeter band 150 that is configured as a peel-apart seal can be proximate to one corner 182 of the multilayer film, can be proximate to two corners of the multilayer film, can be proximate to three corners of the multilayer film, or can be proximate to four corners of the multilayer film. Configuration as a peel-apart seal can be useful such that the interior compartment 155 containing the product 190 can be accessible by at least partially peeling apart the first multilayer film 120 and the second multilayer film 140.

Any portion of the perimeter band 150 that is configured as a peel-apart seal preferably is adapted to or configured to only separate when a sufficiently high peel force is applied. For example, in some embodiments, a section of the perimeter band 150 that is configured as a peel-apart seal can be configured such that the peel-apart seal does not separate below a peel force of about 1.5 pounds per 15 mm of linear distance, about 1.75 pounds per 15 mm of linear distance, or about 2.0 pounds per 15 mm of linear distance. Further, a section of the perimeter band 150 that is configured as a peel-apart seal can be configured such that the peel-apart seal separates at a peel force of about 1 pound to about 3.5 pounds, about 1.25 pounds to about 3.25 pounds, or about 1.5 pounds to about 3 pounds per 15 mm of linear distance.

The presently disclosed package 100 can be configured to provide for secure containment of the product 190 therein while also providing for substantial ease of opening so there is little or no fear of damaging the product during opening. As such, the seal between the first multilayer film 120 and the second multilayer film 140 at the perimeter band 150 preferably is both secure so as to prevent undesired opening and also separated without significant difficulty. The peeling apart of the seal at the perimeter band thus can be carried out in a controlled manner so that only part of the seal around the perimeter band is peeled apart. In this manner, the product 190 may be removed from the package 100, and the interior compartment 155 may remain at least partially defined by the first multilayer film 120 and the second multilayer film 140 so that it provides a compartment for discarding a used product. For example, in embodiments wherein the product 190 is a condom, it can be beneficial for the consumer to be able to deposit the used condom within the interior compartment 155 for disposal. As such, the package 100 or instructions provided therewith may provide instruction to a consumer to only partially peel open the package 100 using the first tab 129 and the second tab 149.

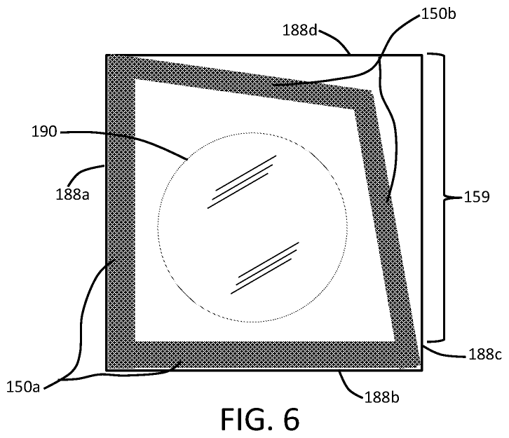

In some embodiments, the package 100 may be adapted to or configured to substantially prevent the first multilayer film 120 and the second multilayer film 140 from being completely peeled apart. For example, one or more sections of the perimeter band 150 may be configured to peel apart at a first peel force, and one or more sections of the perimeter band 150 may be configured to peel apart at a second peel force that is different than the first peel force. With reference to the example embodiment of FIG. 6, the partial length perimeter band segments 150b that are proximate to the tab section 159 (e.g., the first tab 129 and the second tab 149) may be configured as a peel-apart seal that is configured separate at a first peel force, and the full length perimeter band segments 150a can be configured as a peel-apart seal that separates at a second peel force that is greater than the first peel force. In this manner, a consumer may peel apart the seal as formed by the partial length perimeter band segments 150b and then stop the peeling action when encountering a greater peel force indicating that the full length perimeter band sections 150a have been reached. In this embodiment, the packaged product 10 thus may be peeled apart substantially completely along sides 188c and 188d while remaining sealed along sides 188a and 188b.

Similarly, in some embodiments, resisting or preventing complete separation of the package 100 may be achieved by providing only a portion of the seal in the area of the perimeter band 150 as a peel-apart seal. Thus, referring again to FIG. 6, the portions of the perimeter band 150 defined by the partial length sections 150b and that are proximate to the tab section 159 (e.g., the first tab 129 and the second tab 149) can be configured as a peel-apart seal that separates at a defined peel force. The portions of the perimeter band 150 defined by the full length sections 150 can be configured to not be a peel-apart seal—i.e., may be a substantially permanent seal.

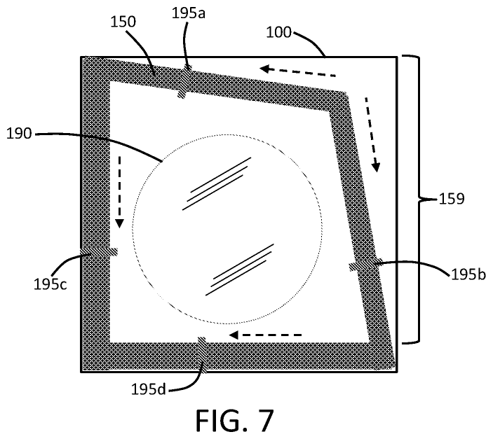

The inner polymer layer 131 of the multilayer film 130 (also first multilayer film 120 and second multilayer film 140) often can be substantially uniform in structure across the surface thereof. As such, implementing differentiated sealing techniques may be more difficult to implement. A uniform sealing technique thus may provide a seal at the perimeter band 150 that is substantially constant in properties (e.g., peel force), and alternate means may be implemented to resist or prevent peeling apart of the multilayer films beyond a desired point. This may include, for example, including in or around the perimeter band one or a plurality of stops. Such stops can be configured to resist peeling apart of the first multilayer film 120 and the second multilayer film 140. For example, FIG. 7 provides an example embodiment of a package 100 including stops 195 at two alternative positions. Stops 195a and 195b are positioned to provide a more limited range for peeling apart of the multilayer films, and stops 195c and 195d are positioned to provide a more expansive range for peeling apart of the multilayer films. It is understood that only one of the sets (i.e., the set defined by 195a and 195b or the set defined by 195s and 195d) of stops 195 need be included in a given package 100, and a set of stops may be provided at any pair of positions around the perimeter band to allow for the desired range of peeling. For example, a plurality (or pair) of stops can be positioned such that, when peeling open the package using the tab section 159, about 30% to about 80%, about 35% to about 75%, or about 40% to about 70% of the perimeter band can be peeled apart prior to reaching the plurality of stops. In FIG. 7, the dashed arrows indicate the direction of peeling to separate the perimeter band 150 when peeling using the tab section 159 (e.g., the first tab 129 and the second tab 149 in FIG. 1).

Although the previously described embodiments illustrate a package 100 having a shape that is substantially a square or substantially a quadrilateral, it is understood that other package shapes are also encompassed by the present disclosure. A package 100, for example, may have a substantially curvilinear shape, such as round, oval, or the like. Moreover, a package 100 may have a rounded edge and at least one straight edge. A package 100 having a substantially round shape is illustrated in FIG. 8. As seen therein, the package 100 includes a first multilayer film 120 and a second multilayer film (not visible in FIG. 8) that are sealably engaged at the perimeter band 150, thus defining an interior compartment 155 wherein is stored a product 190 (in this embodiment, a condom). The first multilayer film and the second multilayer film have an outer edge 101 defining a substantially round profile. The package 100 includes a tab section 159 whereby the consumer may peel apart the first multilayer film and the second multilayer film, which separate at the perimeter band 150. The package 100 may optionally include stops 195a and 195b that may define the limits of how far the perimeter band 150 may be separated. In some embodiments, the perimeter band 150 may include a non-peelable section 151. As illustrated in FIG. 8, the non-peelable section 151 may be defined between the marked location of the stops 195a, 195b; however, it is understood that when section 151 is defined as a non-peelable section, the stops are not necessarily present since the entire non-peelable section may essentially function as a widened stop. Such non-peelable section 151 may likewise be incorporated into any further embodiments described herein. Likewise, it is understood that the non-peelable section 151 may have larger dimensions than illustrated in FIG. 8, for example extending up to approximately 60%, approximately 55%, approximately 50%, approximately 40%, approximately 30%, approximately 20%, or approximately 10% of the overall length of the perimeter band 150. The perimeter band 150 again can be configured to be substantially congruent or coincident with the outer edge 101 of the package 100 except in the area of the tab section 159, which may include an area approaching the tab section.

In some embodiments, the perimeter band 150 may be at least partially re-sealable. For example, the inner polymer layer 131 of the multilayer film (120, 130, 140) may be adapted to or configured to re-seal upon application of pressure after the perimeter band has been initially peeled apart. In particular, when heat sealing has been used, the polymer layer subjected to the heating may remain in a substantially re-sealable condition after the multilayer films are initially peeled apart.

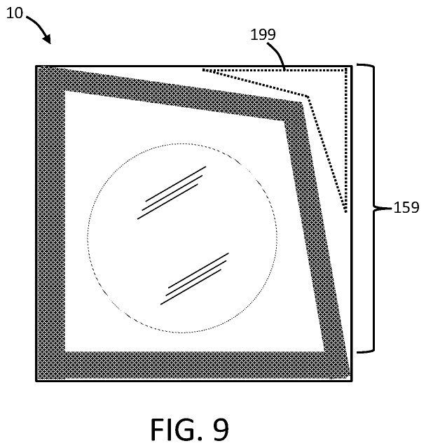

In certain embodiments, one or more indicia may be present on the packaged article 10. The indicia can be used to provide an indication to a user as to the location of the tab section 159, and the provision of such indicia can make it easier for a user to quickly and easily locate the tab section, which not be readily apparent if the two multilayer films remain closely aligned in the area of the tab section 159. A preferred location 199 for placement of the indicia is shown in FIG. 9 by the area bounded by the broken lines. A similar location 199 is illustrated in the embodiment of FIG. 8 by broken lines. The indicia may be present in substantially all or in any portion of the outlined area. If desired, however, indicia may also be placed in other areas. Preferably, the indicia are configured to make it readily apparent where the tab section 159 is located for peeling apart of the two multilayer films. The indicia include one or more words (e.g., “PEEL”), one or more symbols (e.g., stars, arrows, etc.), one or more product trademarks, or combinations thereof.

In one or more embodiments, the present disclosure further can relate to methods of packaging a condom. For example, such methods can comprise positioning a condom between a first multilayer film and a second multilayer film (which can comprise two separate films or a single film that folded over to provide top and bottom layers) and sealing together the first multilayer film and the second multilayer film. Such sealing preferably is provided at only defined areas of the films. For example, sealing of the first multilayer film and the second multilayer film can be carried out substantially only at a perimeter band that substantially surrounds the condom to define a closed, interior compartment in which the condom is contained and to define a first tab on the first multilayer film and a second tab on the second multilayer film, the first tab and the second tab being exterior to the perimeter band. In some embodiments, the sealing can be carried out such that at least a section of the perimeter band proximate to the first tab and the second tab is configured as a peel-apart seal such that the interior compartment containing the condom is accessible by at least partially peeling apart the first multilayer film and the second multilayer film. The sealing can be carried out so as to provide a variety of packaged articles as otherwise described above.

In some embodiments, the present disclosure also can relate to methods of accessing a condom and/or for improving ease of access to a condom. Such methods can comprise providing a condom in a package that is peelable to provide access to the condom. The package may be any package configuration as described herein that includes multilayer films that are sealed at a perimeter band that substantially surrounds the condom and that defines a tab section with tabs that may be gripped for peeling apart the multilayer films for accessing the condom.

Where various numerical values are modified herein with use of the word “about” it is understood that the values can mean the exact value stated. The stated value as modified by the word “about”, however, can vary by a relatively small amount, such as +/−5%, +/−4%, +/−3%, +/−2%, or +/−1% of the exact value.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A packaged article comprising:
a first multilayer film;
a second multilayer film; and
a product;
wherein the first multilayer film and the second multilayer film are sealingly engaged one to another substantially only at a perimeter band that defines a closed, interior compartment in which the product is contained and which defines a first tab on the first multilayer film and a second tab on the second multilayer film, the first tab and the second tab being exterior to the perimeter band; and
wherein at least a section of the perimeter band proximate to the first tab and the second tab is configured as a peel-apart seal such that the interior compartment containing the product is accessible by at least partially peeling apart the first multilayer film and the second multilayer film.

2. The packaged article of claim 1, wherein the first multilayer film and the second multilayer film each comprise at least an inner, polymeric layer and at least one structural layer that is exterior thereto.

3. The packaged article of claim 2, wherein the at least one structural layer includes one or more of a foil layer, a polyolefin layer, and a polyester layer.

4. The packaged article of claim 2, wherein the at least one structural layer is effective as one or both of an oxygen barrier and a moisture barrier.

5. The packaged article of claim 2, wherein the polymeric layer of the first multilayer film and the second multilayer is formed of a material that is configured to form the peel-apart seal upon application of an activating factor.

6. The packaged article of claim 5, wherein the activating factor is one or a combination of heat, pressure, and dwell time.

7. The packaged article of claim 1, wherein the at least a section of the perimeter band that is configured as a peel-apart seal is configured such that the peel-apart seal does not separate below a peel force of about 1.5 pounds per 15 mm of linear distance.

8. The packaged article of claim 1, wherein the at least a section of the perimeter band that is configured as a peel-apart seal is configured such that the peel-apart seal separates at a peel force of about 1.5 pounds to about 3.0 pounds per 15 mm of linear distance.

9. The packaged article of claim 1, wherein a first section of the perimeter band proximate to the first tab and the second tab is configured as a peel-apart seal and is configured such that the peel-apart seal separates at a first peel force, and a second section of the perimeter band is configured as a peel-apart seal and is configured such that the peel apart seal separates at a second peel force that is greater than the first peel force.

10. The packaged article of claim 1, wherein a first section of the perimeter band proximate to the first tab and the second tab is configured as a peel-apart seal and is configured such that the peel-apart seal separates at a defined peel force, and a second section of the perimeter band is configured to not be a peel-apart seal.

11. The packaged article of claim 1, wherein the perimeter band includes a plurality of stops that are configured to resist peeling apart of the first multilayer film and the second multilayer film.

12. The packaged article of claim 11, wherein the plurality of stops are positioned relative to the first tab and the second tab such that about 30% to about 80% of the perimeter band can be peeled apart prior to reaching the plurality of stops.

13. The packaged article of claim 1, wherein the first multilayer film and the second multilayer film have substantially the same size and shape.

14. The packaged article of claim 1, wherein the perimeter band is re-sealable.

15. The packaged article of claim 1, wherein the first multilayer film and the second multilayer film each comprise four corners and four sides.

16. The packaged article of claim 15, wherein the at least a section of the perimeter band that is configured as the peel-apart seal is proximate to two of the four corners.

17. The packaged article of claim 15, wherein the first tab and the second tab encompass a first corner of the four corners and extend to two adjacent corners.

18. The packaged article of claim 15, wherein the perimeter band is configured with two substantially full length perimeter band sections that interconnect at one of the corners in a substantially right angle.

19. The packaged article of claim 15, wherein the perimeter band is configured with a partial length perimeter band section extending from one of the corners along one of the sides.

20. The packaged article of claim 19, wherein the partial length perimeter band section includes an outer edge, and wherein the partial length perimeter band section is angled relative to the side so as to form an angle of about 1 degree to about 60 degrees.

21. The packaged article of claim 15, wherein the perimeter band is configured with two partial length perimeter band sections extending from two, opposing corners along two adjacent sides toward a third corner interconnecting the two adjacent sides.

22. The packaged article of claim 21, wherein each of partial length perimeter band sections includes an outer edge, and wherein the partial length perimeter band sections are individually angled relative to their respective sides so as to form an angle of about 1 degree to about 60 degrees.

23. The packaged article of claim 1, wherein the first multilayer film and the second multilayer film have a substantially curved edge.

24. The packaged article of claim 23, wherein the first multilayer film and the second multilayer film have an outer edge defining a substantially round or oval profile.

25. The packaged article of claim 1, wherein the product is a condom.

26. A method of packaging a condom comprising:
positioning a condom between a first multilayer film and a second multilayer film; and
sealing the first multilayer film and the second multilayer film substantially only at a perimeter band that substantially surrounds the condom to define a closed, interior compartment in which the condom is contained and to define a first tab on the first multilayer film and a second tab on the second multilayer film, the first tab and the second tab being exterior to the perimeter band;
wherein the sealing is carried out such that at least a section of the perimeter band proximate to the first tab and the second tab is configured as a peel-apart seal such that the interior compartment containing the condom is accessible by at least partially peeling apart the first multilayer film and the second multilayer film.

27. A method for improving ease of access to a packaged condom, the method comprising providing a condom within a sealed, peelable package.

28. The method of claim 27, wherein the sealed, peelable package comprises:
a first multilayer film; and
a second multilayer film;
wherein the first multilayer film and the second multilayer film are sealingly engaged one to another substantially only at a perimeter band that defines a closed, interior compartment in which the condom is contained and which defines a first tab on the first multilayer film and a second tab on the second multilayer film, the first tab and the second tab being exterior to the perimeter band; and
wherein at least a section of the perimeter band proximate to the first tab and the second tab is configured as a peel-apart seal such that the interior compartment containing the condom is accessible by at least partially peeling apart the first multilayer film and the second multilayer film.
